(19) United States
(12) Patent Application Publication
(10) Pub. No.: US 2017/0213262 A1
(43) Pub. Date: Jul. 27, 2017

(54) PARKING VALIDATION WITH INTELLIGENT PARKING METERS

(71) Applicant: Municipal Parking Services, Inc., Minnetonka, MN (US)

(72) Inventors: Richard W. KELLEY, II, Corcoran, MN (US); David E. COLLINS, JR., Plymouth, MN (US); Marcus N. SCHMIDT, Minnetonka, MN (US); Steven B. LANE, Maple Grove, MN (US); Umarani PANDIAN, Durham, NC (US); John J. LEIER, Brooklyn Park, MN (US); Mark J. MORAN, Woodbury, MN (US)

(21) Appl. No.: 15/416,938

(22) Filed: Jan. 26, 2017

Related U.S. Application Data
(60) Provisional application No. 62/287,354, filed on Jan. 26, 2016.

(51) Int. Cl. G06Q 30/02; G06Q 20/32; G06Q 20/10

(52) U.S. Cl. CPC G06Q 30/0284; G06Q 30/0238; G06Q 20/10; G06Q 20/3223; G06Q 20/3276; G06Q 30/0259

(57) ABSTRACT

Parking validation systems and methods are disclosed for managing parking events and providing a merchant the ability to validate parking for their customer. A network of intelligent parking meters is networked with a central control computer system. The merchant sets up a validation account. The merchant can set alterable parameters of their account. The parker can scan a QR code, provided by a merchant, using a mobile parking application or can scan a parking coupon at the parking meter or kiosk. The merchant's point of sale system in other embodiments can interface with the central computer over the network to validate the parking of a customer of that merchant. The merchant's validation account is debited the validation amount.

### PRIORITY

This application claims the priority benefit of U.S. Provisional Application No. 62/287,354, filed on Jan. 26, 2016, which is hereby incorporated herein by reference in its entirety.

### FIELD

The present invention relates generally to parking systems and, more particularly, to parking validation management systems and methods using intelligent parking meters.

### BACKGROUND

Intelligent parking meters such as those disclosed in U.S. Pat. Pub. Nos. 2014/0214499 A1 and 2014/0214500 A1 (which are both incorporated herein by reference in their entirety) provide for parking meters and parking lot monitoring systems that can sense the presence of a vehicle in (or entering/exiting) a parking space or lot, determine the identity of the vehicle, permit the parking user to pay for parking, issue parking violation notices, and other intelligent functions. Each of the meters in these applications is also networked with a central or control computer for added control and functionality. Such intelligent meter systems can be further leveraged for greater control and management of parking events, and for added marketing and sales opportunities by one or both of merchants and parking authorities.

### SUMMARY

The present invention provides unique devices, systems and methods for managing parking events and providing a merchant the ability to validate parking for customers. A network of intelligent parking meters is networked with a central control computer system. The merchant sets up a validation account. The merchant can set alterable parameters of their account. The parker can scan a QR code, provided by a merchant, using a mobile parking application or can scan a parking coupon at the parking meter or kiosk. The merchant's point of sale system in other embodiments can interface with the central computer over the network to validate the parking of a customer of that merchant. The merchant's validation account is debited the validation amount.

The disclosure includes a method of validating a parking fee for a parking event occurring at a parking space monitored by a smart parking meter. The smart parking meter is networked with a central control computer. The merchant establishes a validation account, including setting a plurality of validation parameters maintained in a memory of the central control computer system. The merchant provides a customer with a validation coupon for the parking event. The smart parking meter receives the coupon. The validation account of the merchant is then debited.

The customer can scan the coupon using a smart phone where the smart phone executes a software program that relays the coupon to the smart parking meter via the central control computer. The customer can also scan the coupon at the smart parking meter. The smart parking meter then transmits data relating to the coupon to the central control computer.

The plurality of validation parameters includes the merchant's ability to set a maximum dollar amount of an aggregate sum of all coupons that can be issued and a customized message to be displayed on the coupon.

A report can be generated for a plurality of parking event data stored by the central control computer, including the number of redeemed validation coupons for the merchant.

The coupon can be a QR code, which can be in either paper or electronic form.

An advertisement can be displayed on a display screen of the smart parking meter that indicates to the customer that the merchant will validate parking for purchases made from the merchant.

The disclosure further includes a method of validating a parking fee for a parking event occurring at a parking space monitored by a smart parking meter wherein the merchant's point of sale system is networked with the central control computer (via application programming interface or other means). A validation account is established by a merchant, including setting a plurality of validation parameters that are maintained in a memory of the central control computer system. A smart parking meter is networked with the central control computer. The merchant indicates to the central control computer via the POS system that the parking event for a customer is to be at least partially validated. The validation account of the merchant is then debited accordingly.

The central control computer can match a first credit card number used by the customer to make a purchase via the merchant POS system with a second credit card number used by the customer to purchase parking time via the smart parking meter.

The merchant POS system can receive a parking meter identification data corresponding to the smart parking meter monitoring the parking event to be validated. The parking meter identification data can be a code (e.g., QR code or bar code) shown on a customer's smartphone.

The disclosure additionally includes a parking monitoring and validation system, comprising a parking meter configured to automatically monitor a parking space; and a central control computer located remotely from the parking meter. The central control computer is networked with the parking meter. The central control computer is configured to receive a merchant parking validation input and communicate to the parking meter that some or all of a parking event being monitored by the parking meter has been validated. The central control computer is further configured to deduct a dollar amount corresponding to the merchant parking validation input.

The central control computer can be further configured to match a first credit card number used by the customer to make a purchase via the merchant POS system with a second credit card number used by the customer to purchase parking time via the parking meter.

The merchant parking validation input can be a QR code or other scannable code scanned via a smartphone application or at the parking meter. The smartphone can be networked with the central control computer via an application executing on the smartphone.

The central control computer can be configured to command the parking meter to display a message advertising parking validation for customers making purchases from a merchant located within a pre-set proximity of the parking meter.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIGS. 1A and 1B are front and back views, respectively, of a smart parking meter according to certain example embodiments.

FIG. 2 is a diagram of a vehicle in a parking space being monitored by a smart parking meter according to certain example embodiments.

FIG. 3 is another diagram of a vehicle in a parking space being monitored by a smart parking meter according to certain example embodiments.

FIG. 4 is a diagram of various smart parking meter system components according to certain example embodiments.

FIG. 5 is a diagram of various components of an integrated parking system according to certain example embodiments.

FIG. 6 is a merchant validation setup graphical user interface according to certain example embodiments.

FIG. 7 is a QR code according to certain example embodiments.

FIG. 8 is a sheet of QR code coupons according to certain example embodiments.

FIG. 9 is a logic diagram of a method of parking validation according to certain example embodiments.

FIG. 10 is a logic diagram of a method of parking validation according to certain example embodiments.

FIG. 11 is a parking analysis report according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

Provided is a system to allows merchants to validate customer parking at smart parking meters in order to attract and reward customers for purchases made from that merchant. Offering parking validation builds customer loyalty. Validation also removes a practical hurdle for merchants with a physical location that is only near metered parking along a street, or other parking spaces and lots that require pre-payment, and are not networked.

Validation can include compensation for a dollar value of a parking event, a discounted rate for a parking event, a credited or free time period for a parking event, or a combination of any of the foregoing.

Validations can be given by a merchant to a customer making a purchase of any kind, or for making a purchase over a pre-set dollar amount. Validation promotions can also be utilized where parking is free with certain purchases. Differing amounts of validation can be offered depending on merchant-selected variables, such as dollar amount, specific items and previous transactions.

Many merchants also offer customer loyalty programs and branded credit cards to their customers. The merchants can use the validations as enticements to join or sign up with their rewards programs, loyalty programs and/or credit card programs.

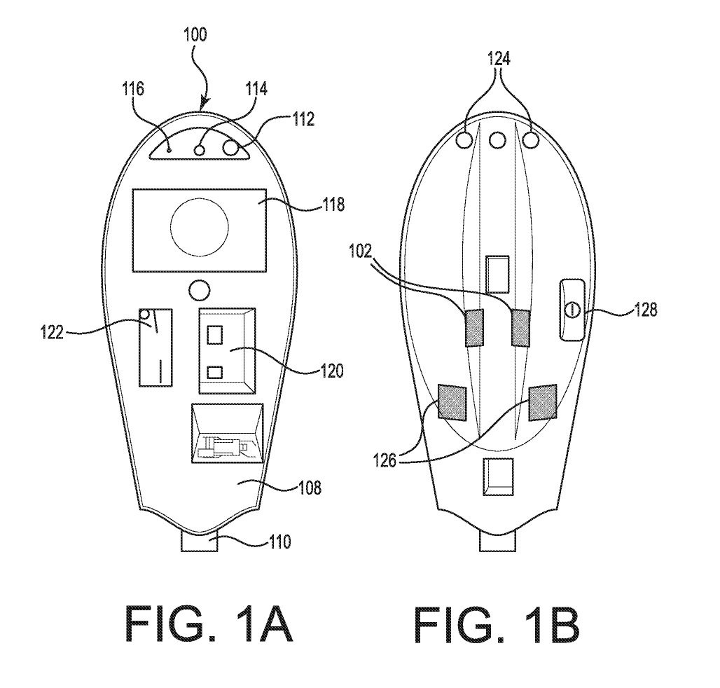

Referring to FIGS. 1A, 1B, 2 and 3, smart parking meters 100, such as those disclosed in U.S. Pat. Pub. Nos. 2014/0214499 A1 and 2014/0214500 A1 (which are both incorporated herein by reference in their entirety herein), can be deployed adjacent to various parking spaces in the vicinity of the merchant that wishes to issue validations. Such smart meters can include one or more cameras 102 arranged to monitor parking spaces 104 adjacent to the meter. The cameras 102 can be configured to capture video or still images.

As explained in U.S. Pat. Pub. No. 2014/0214499 A1, the meters 100 include microprocessors, memory and computer code that enable the meters to monitor parking events, including determining the presence of a vehicle 105 in a parking space 104, determining the identity of the vehicle, permitting the parking user to pay for parking time, determining parking violation notices, and other intelligent functions.

A computer readable program code can be stored in the physical memory (e.g., random access memory, flash memory or hard-drive) of the meter. The computer readable program code is configured such that when executed by the microprocessor, the code causes the meter to perform the steps of the invention described herein.

Referring to FIGS. 1A and 1B, each parking meter 100 in certain embodiments includes an enclosure 108 mounted atop a pole 110. The housing 108 includes the electronics components mentioned above. In addition, the housing includes, on the front side, a speaker 112, user-facing camera 114 and microphone 116 disposed adjacent to the graphical user interface (e.g. touch screen) 118. A payment acceptance means 120 and coin slot 122 are also provided. The payment acceptance means can be a contactless or conventional card reader, or other known means for accepting payment. The payment acceptance means can also include the user-facing camera 114, vehicle-facing cameras 102, or other optical scanners configured to read QR codes and the like.

The rear side of the housing 108 includes a plurality of violation indicator lights 124, windows through which the cameras 102 can see, infrared (IR) illuminators 126 to provide supplemental IR light to aid the cameras' sight, and a lock mechanism 128 to keep unwanted persons from opening the housing 108.

Each of the meters 100 can also be networked with a central or control computer for added control and functionality as explained in U.S. Pat. Pub. No. 2014/0214499 A1 and as further discussed herein. Further, one smart meter 100 can be networked with one or more remote cameras disposed adjacent to additional parking spaces so that one meter can monitor several different parking spaces and parking events.

The same or similar smart parking meter 100 can also be configured as a kiosk and placed adjacent to a parking lot or ramp to monitor entry and exit events at a lot or ramp as explained in U.S. Pat. Pub. No. 2014/0214500 A1. A kiosk can also simultaneously function as a parking space meter. A single kiosk or meter can further be coupled to one or more remote cameras that each monitor individual parking spaces so that the single kiosk or meter monitors multiple individual parking spaces or events throughout a lot, ramp or street segment.

Note that when the term meter is used throughout this application, such use should be understood to include both smart meters and kiosks.

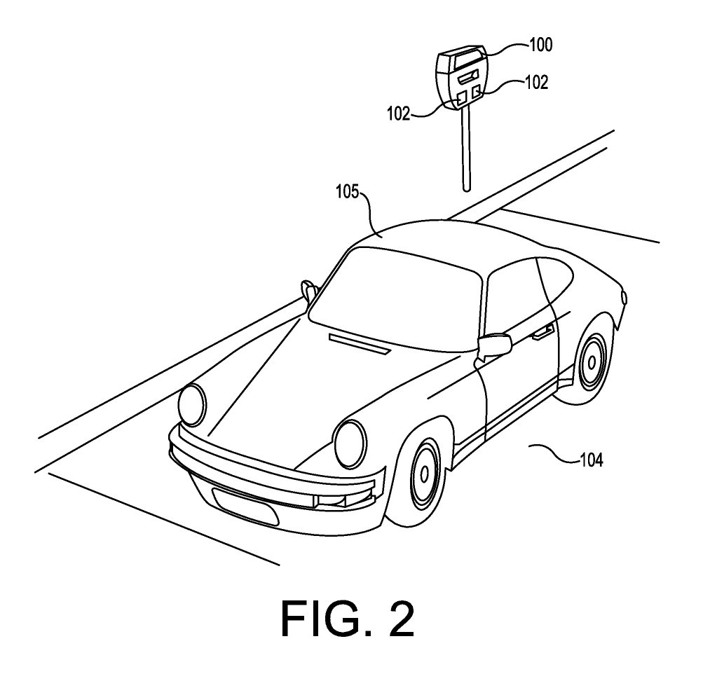

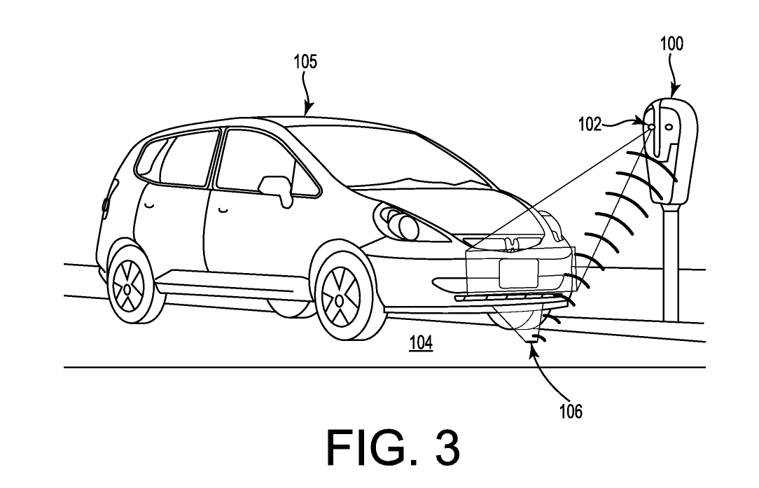

Referring now to FIGS. 2-3, the smart parking meter 100 includes a camera 102 to view a portion of a vehicle when the vehicle 105 is located in the parking space 104 being monitored. In FIG. 2, the rear side of the vehicle 105 is monitored by the camera 102. In FIG. 3, the front side of the vehicle 105 is monitored by the camera 102.

In addition, an in-ground sensor 106 is embedded in the road underneath the vehicle 105 when the vehicle is present in the parking space 104. The in-ground sensor 106 can also be located in alterative positions such as in the curbing.

The in-ground sensor 106 is preferably a magnetic sensor. The sensor can be disc-shaped to facilitate embedding in the roadway. The sensor 106 can alternatively perform sensing of the vehicle using other means such as radar.

The in-ground sensor 106 broadcasts a status message to the nearby meter 100 as shown in FIG. 3. The broadcast can be performed using low power Bluetooth or other short range wireless communications protocol. The broadcast frequency can be continuous or periodic. For example, the status of the in-ground sensor 106 can be broadcast once per second, ten times per second, etc.

In one preferred embodiment, the magnetic in-ground sensor 106 is powered by an internal lithium-based battery and a sensing/broadcast cycle is performed once per second in order to conserve battery life. A sensor life expectancy of several years can be achieved using such battery and operating method. In other embodiments, the in-ground sensor can be hard-wired for power and/or broadcast.

Machine vision can be employed to monitor the presence and absence of a vehicle in the parking space being monitored. Such methods and systems are disclosed in U.S. patent application No. 15/335,978, filed Oct. 27, 2016, which is hereby incorporated herein by reference in its entirety.

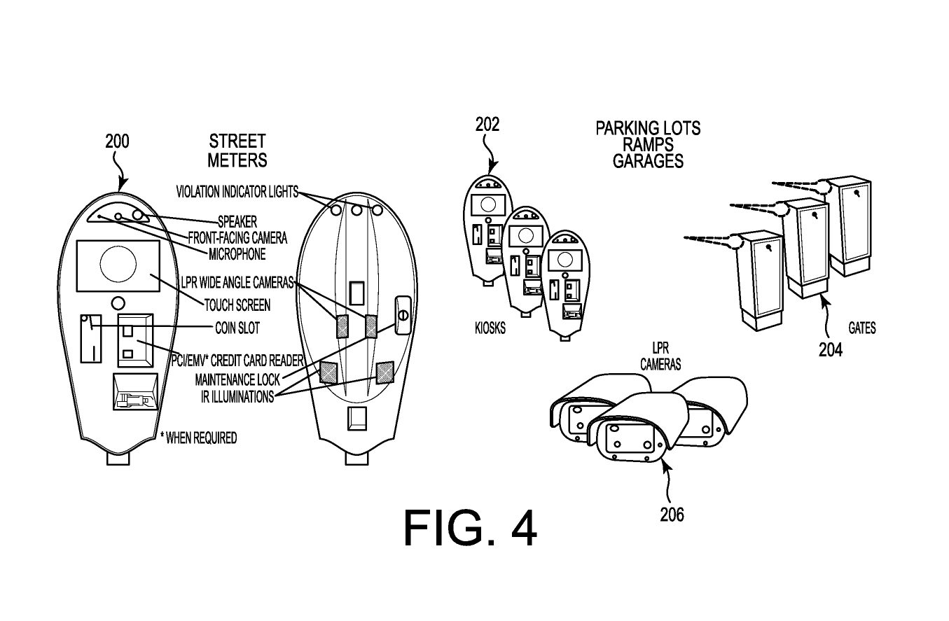

Referring to FIG. 4, various components of a smart parking system 200 with validation are shown. Smart parking meters 200 can be deployed adjacent to various parking spaces. Each of the meters 200 is also networked with a central or control computer for added control and functionality.

The same or similar smart parking meter 200 can also be configured as a kiosk 202 and placed adjacent a parking lot or ramp. The kiosk 202 is coupled to gates 204 and/or license plate reading (LPR) cameras 206 to monitor parking events at a lot, ramp or garage and control the flow of vehicles into and out of the parking facility.

A kiosk 202 can also simultaneously function as a parking meter 200. A single kiosk or meter 202 can further be coupled to one or more LPR cameras 206 that each monitor individual parking spaces so that the single kiosk or meter 202 monitors multiple individual parking spaces or events.

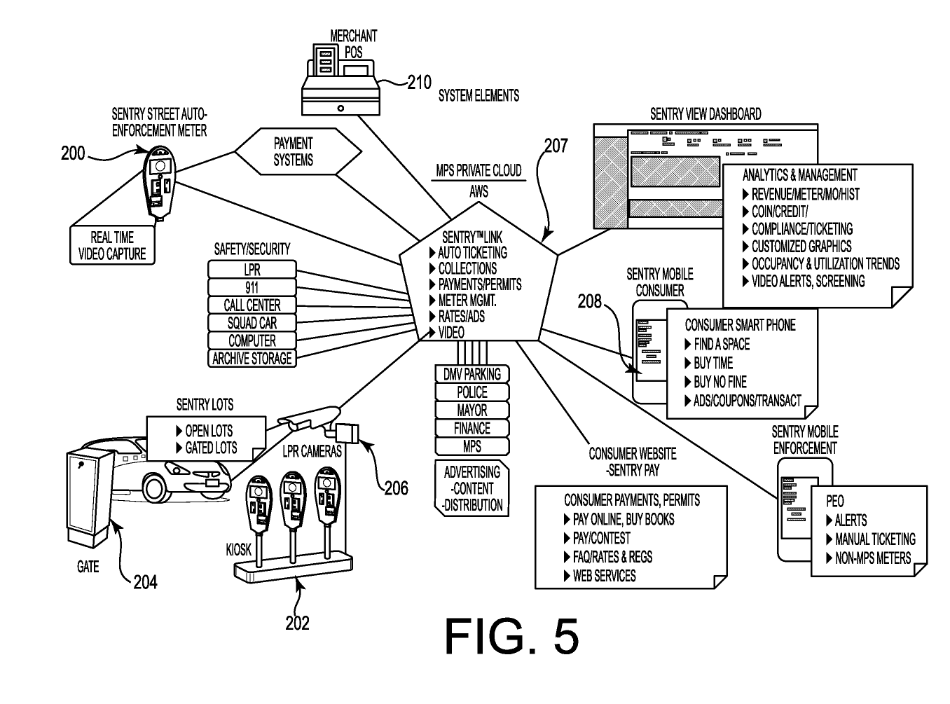

Referring to FIG. 5, each meter 200 and kiosk 202 is communicatively coupled or networked to the so-called cloud computing system 207 via the internet or other wired or wireless connection. The cloud computing system 207 can also be referred to as a central or control computer or server.

The cloud computing system 207 comprises one or more computer systems located remote from the meters and kiosks that is networked with the meters 200 and kiosks 202. The network can be wired or wireless, and the network can be either a private network (local area network or LAN) or a public network such as the world wide web (the Internet).

Computing devices 208 such as smart phones, tablet computers, laptops and personal computers can communicate with the meters 200 and kiosks 202 via the cloud server 207. A merchant's point of sale (POS) system 210 can also be networked with the cloud server 207.

The computing devices 208 and merchant POS systems 210 each include a microprocessor, physical memory coupled to the microprocessor, a graphical user interface, an input device (keyboard, mouse and/or touch-sensing display screen) and a network interface coupled to the microprocessor. The physical memory can be a non-transitory memory.

The network interface is configured to enable communication with a communication network (e.g. the Internet or World Wide Web), using a wireless connection (e.g. cellular such as LTE, Wi-Fi, etc.).

The memory in the computing devices 208 and POS systems 210 may include one or more non-volatile storage devices and/or one or more volatile storage devices (e.g., random access memory (RAM)).

The parking validation can be accomplished via several methods using the systems described above.

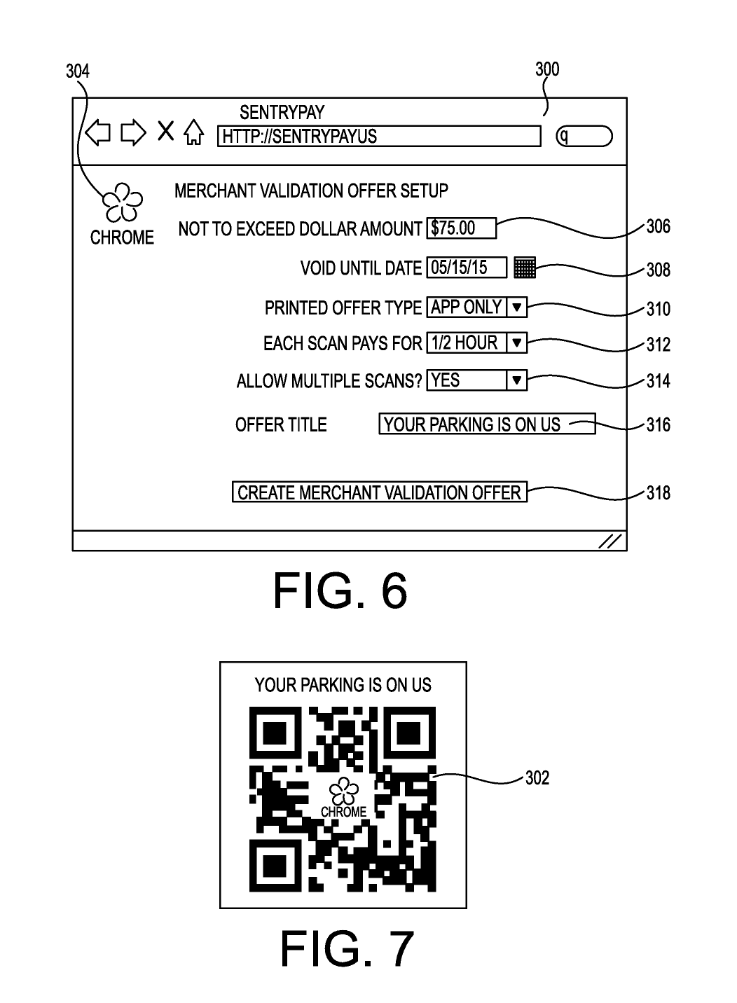

A first method of merchant validation will now be described with reference to FIG. 6, which is a setup screen 300 for the merchant, and FIG. 7, which is a QR code 302.

First, a merchant uses a computing device 208 connected to the internet to set up a merchant account with the control computer 207 system that interfaces with the parking meters 200 to be validated. The merchant provides their basic information such as store name, address, closest meter locations, etc.). The merchant then sets their password and uploads a logo 304. The logo can be used for the parking control system to create custom QR codes 302 and coupons.

The merchant can also interface with the central control computer 207 to set up custom advertisements that the merchant wants to be broadcast to parkers at nearby meters. The broadcast can be visual using the meter's main display 118, or verbal using the meter's speaker 112, or both.

Once the merchant has set up their account, they are ready to make merchant validation offers. A validation offer allows a merchant to validate parking for one or more of their customers that parked at a smart meter 200 connected to the control computer 207 (“parkers” as used herein). The end-result of a validation offer is a QR code 302 that the parker can scan with a mobile parking application on a mobile computing device (such as disclosed in U.S. patent application Ser. No. 15/223,301, filed Jul. 29, 2016, which is hereby incorporated fully herein as part of this application) to have a portion, or all of, the parker's parking cost refunded.

The merchant has flexibility to set up their validation offers according to several alterable parameters. Examples of the alterable parameters are shown in FIG. 6, which is a graphical user interface 300 for the merchant to set up and modify their account that allows the merchant to interact with the central control computer 207 to set such parameters. The parameters include: maximum dollar amount of aggregate sum of all validations 306 that can be issued, expiration date of the validation offer 308, type of coupon redemption method 310, amount of time redeemable per coupon 312, ability to use multiple validation coupons in single transaction 314, and a customizable message 316 that will be displayed to the parker upon issuance of the coupon.

The setup screen 300 in FIG. 6 (or multiple such screens) can include more or fewer alterable parameters without departing from the scope of the invention.

Once the merchant finishes entering their alterable parameters in interface 300, they choose the option to “create merchant validation offer” 318. Then the merchant's credit card (entered as part of the set up process) is charged for the entire offer amount plus any transaction fee that is applicable.

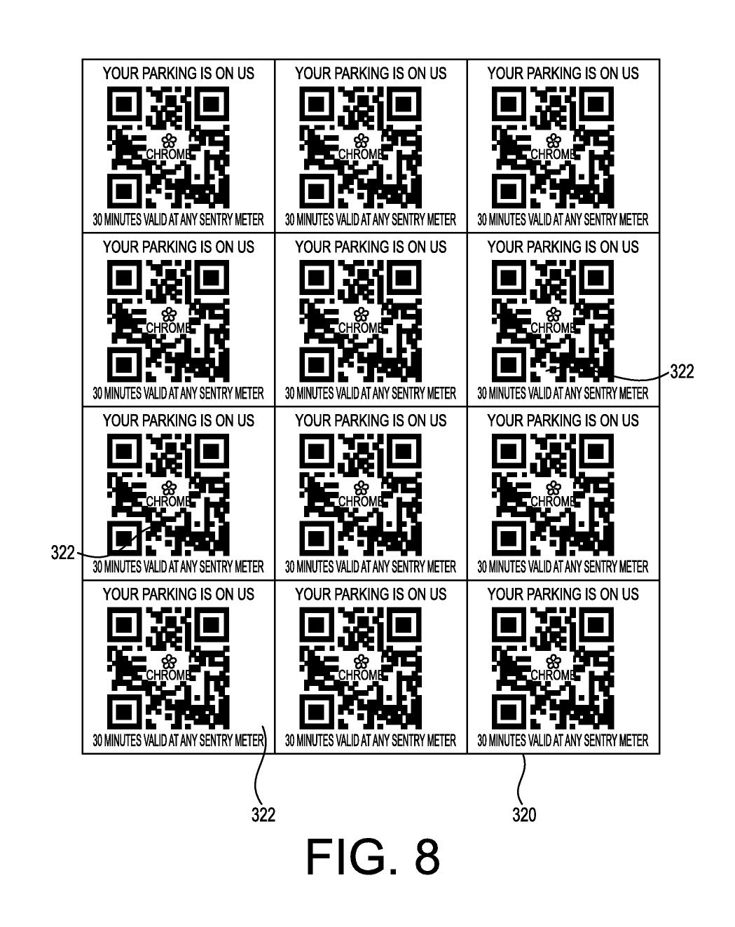

The merchant has the option to generate a single QR code coupon 302 as shown in FIG. 7, which the parkers can scan using the parking system mobile application executing on the parker's own mobile computing device. The merchant can alternatively, or additionally, print out a sheet 320 comprising multiple individual QR code “coupons” 322 as shown in FIG. 8. A single coupon can be handed to the parker to allow the parker to validate at the meter 200 or later via the mobile application. The meter or kiosk can include a scanner to read the coupons as noted previously.

The QR codes can contain individual unique embedded codes which are generated by the central control computer and known only to the control system and, via the network, the smart parking meters. These unique codes ensure that users cannot simply copy and re-use the QR codes, and that the exact usage of each and every code can be tracked.

The central control computer 207 can be configured to broadcast a message to parkers in the vicinity of the merchant that the merchant is offering parking validation. A message regarding the validation offer can be displayed on the displays of the parking meters in the vicinity of the merchant as well. A verbal broadcast message can also be provided via the speakers of the meters.

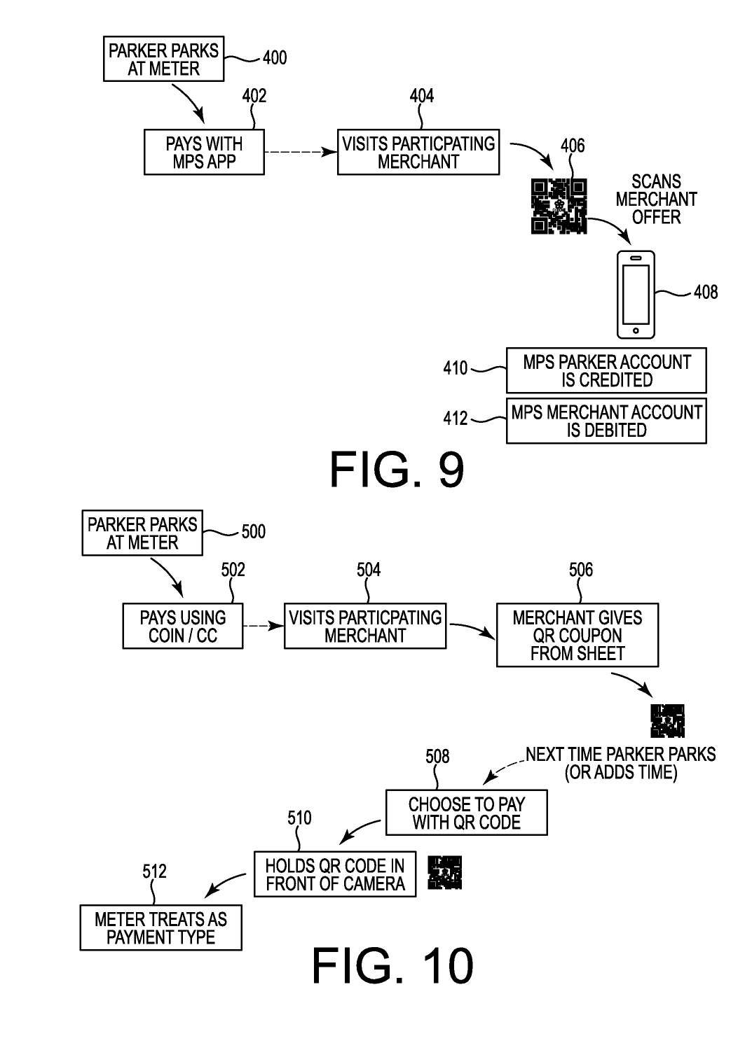

Referring now to FIG. 9, a parking and validation procedure using the mobile parking application will now be discussed. The parker first parks in a parking spot that is associated with the smart meter/lot system 400. Then the user pays for a parking time or period with the mobile app on their mobile computing device 402. The customer now goes shopping.

The shopping includes making a qualifying purchase from a merchant that has a merchant validation account with the parking management company 404. The merchant presents the parker with the merchant's QR validation code 406 and the parker selects the “validate parking” function with their mobile parking application on their computing device. The computing device scans or takes a picture of the QR code 408 which relays the encoded information to the central control computer. Note that the merchant keeps a printout copy of the QR validation code nearby their point of sale system so that it is handy to present to the parker that makes a qualifying purchase.

The central control computer validates the scanned merchant QR code. This includes ensuring that the QR code is still valid. The central computer credits the parker's account 410 for the dollar amount of the validation corresponding to the “each scan pays for” setting of FIG. 6 and deducts that same amount from the merchant's validation balance 412. The customer is provided with a confirmation that the validation has been applied. The custom message 318 on behalf of the merchant noted in FIG. 6 can be provided with the confirmation to the parker to reinforce the feeling of loyalty and gratitude of the parker to the merchant.

If the parker does not utilize the mobile parking application associated with the smart parking meters, then validation can be provided by the following alternative methodology. Referring now to FIG. 10, after the parker parks at the monitored meter 500 same as before, they now pay using a credit card, coin or other monetary payment via the meter or a parking kiosk associated with their parking space 502. The customer now goes shopping and makes a qualifying purchase same as above 504. However, this time the parker cannot scan a code with their computing device, so the merchant provides a single-use QR code coupon from a sheet of such coupons 506. Since each coupon is good for a certain creditable parking time period, the merchant may elect to give the parker multiple coupons that will add up to provide a longer validation period than a single coupon.

The parker now returns to their parking meter or kiosk. The parker selects the “pay with merchant coupon” option 508 on the meter/kiosk and holds the QR code coupon in front of the camera (which faces the parker when they are facing the meter's screen) 510. The camera reads the code and relays the code information to the central control computer for validation same as above. Again, the user receives a credit (e.g. credit card, user account, PAYPAL, etc.) and the merchant's account is debited the validation amount 512.

Note that each QR code coupon in this scenario is individualized when issued so that it cannot be used twice or replicated. This means that each coupon (e.g., 322 in FIG. 8) on a sheet of coupons 320 is unique and can be tracked by the central control computer to ensure no duplicate usage.

The parker could also elect to use the QR code coupon to proactively pay for parking time at a future event (or for additional time at the current event) rather than use immediately for reimbursement.

The central control computer stores all parking events in memory. Thus, the merchant can query the central control computer to generate various reports regarding the parking data for parkers that parked at monitored meters in the vicinity of the particular merchant (their “meter group”). The report data can be provided for any time period such as daily/weekly/monthly, etc. and include any parking metric stored in memory.

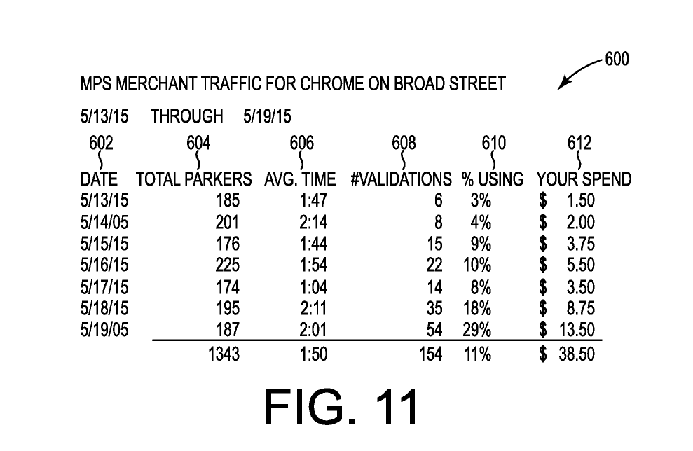

For example, referring to the report 600 shown in FIG. 11 for the merchant “Chrome” for the “Broad Street” meter group, the data can include metrics for date 602, the total number of parking events for the meter group on the date 604, the average parking time per event 606, the number of parkers that are using the merchant's validation codes 608, the percentage of validations compared to total parking events 610, and the merchant's total expense of the validations on that date 612. Totals are also provided for each column. Thus, the merchant can analyze the correlation of parkers in their meter group to their patrons that receive validations. This can reveal the value of validations to the merchant's business performance.

The merchant can easily access detailed reports of their validations to augment marketing analytics. The data can include demographics about the parkers and/or the parked vehicles in the monitored areas surrounding the merchants. The demographics information can be obtained from various public and governmental databases.

The merchant reports are also useful to advise the merchant of their remaining validation offer balance so that they can add more credit, if necessary. A notification can be sent to the merchant when their balance drops below a certain pre-set threshold for the same reason.

In certain aspects, the only credit card charge occurring is the monthly charge by the merchant for purchasing their chosen allotment of validations. This minimizes the overall number of credit card transactions and associated fees.

When a parker parks in a particular space, they can be provided with an advertisement, coupon or other message informing the parker that the merchant associated with that meter grouping is offering validations for parking (and optionally any associated qualifications). The message can be a simple “Come visit (Name of Merchant) and your parking is on us!” The message can be served to the parker's mobile parking application if being used, and can be displayed on the parking meter as well.

The merchant can also be provided with the ability to log into their account with the central control computer and disable or terminate their validation codes. This can be useful, for example, in the even that a sheet of validation coupons is stolen from the merchant.

Note that any form of electronic or virtual payment systems can be utilized with the present invention, including PAYPAL, SHOPKICK, CHECKOUT 51, etc.

In another validation embodiment, the merchant's point of sale (POS) systems are networked with or interface with the central control computer via the internet to generate a one-time discount code for a specific customer. The networking or interfacing can be via an application programming interface (API).

In one embodiment, the merchant's POS system is networked with the central control computer that controls the smart parking meters. The POS system then queries the central computer for a one-time unique discount code, which is then printed on the customer's receipt (in any alphanumeric or coded format (e.g. QR code)) or sent to the customer's smart phone. The customer can then enter or scan the discount code at their specific meter to obtain the discount. The discount is then credited against any payment the customer already made for that parking event.

In yet another embodiment, the customer can provide the merchant with the identity of the particular parking space to be discounted at the time of purchase in the merchant's store. This can be done in several ways. In one embodiment, the customer's data from their payment means (e.g. credit card) is matched up against vehicle registration data of all vehicles parked at the smart parking meters in a certain radius via the central control computer. The central control computer will know the identity of any registered owner of a vehicle if that registration is in a registration database. The database can be based upon governmental records and/or parking users with a parking account established with the parking management company and/or municipality. In this embodiment, the credit card data known to the POS is transmitted to the central control computer along with the credit time/value data and the central control computer locates the vehicle as described above, and then credits the validation amount. If no match can be found, then the central computer returns a fail notice to the POS and the customer can be prompted for an alternate space identification method.

In a further embodiment, the customer's interaction upon beginning a particular parking event generates a unique parking identifier for merchant's validation use. For example, upon submitting payment at the intelligent meter, the user receives a text, email, or other electronic message from the meter (and recorded in the central computer) to the user's personal computing device (e.g., smartphone). The electronic message can be in the form of a scannable code or other code methodology. The merchant then scans or enters the code at the POS, which then interfaces with the central computer to transmit the validation to the specific meter where the customer's vehicle is parked.

If the merchant exhausts the balance in their validation account, then additional validations can be denied by the central computer until a positive balance is restored, including restoration above a pre-selected threshold.

Alternatively, the merchant can be billed periodically for the sum of the validation amounts rather than requiring a positive balance to be maintained in the validation account.

The parking validation systems and methods described herein can be accomplished completely digitally in certain embodiments, so no physical papers need be generated. Digital interaction minimizes the possibility for fraudulent and counterfeit validations.

The advertising and validations allow a merchant to leverage their physical store location via the nearby metered parking spaces. The validations also allow the merchant to better compete with other merchants that have on-site parking. The validations also permit the merchant to build customer loyalty.

The present invention can also benefit the parking authority because the validations may result in increased merchant and parker interactions. Validations can also serve to drive increased adoption and use of a mobile consumer parking application for smartphones and other consumer mobile computing devices.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A method of validating a parking fee for a parking event occurring at a parking space monitored by a smart parking meter, the smart parking meter being networked with a central control computer, the validation method comprising:
establishing a validation account by a merchant, including setting a plurality of validation parameters maintained in a memory of the central control computer system;
the merchant providing a customer with a validation coupon for the parking event;
receiving the coupon by the smart parking meter; and
debiting the validation account of the merchant.

2. The method of claim 1, wherein the step of receiving the coupon comprises the customer scanning the coupon using a smart phone, the smart phone executing a software program that relays the coupon to the smart parking meter via the central control computer.

3. The method of claim 1, wherein the step of receiving the coupon comprises the smart parking meter scanning the coupon, and the method further comprises the smart parking meter transmitting data relating to the coupon to the central control computer.

4. The method of claim 1, wherein the step of setting a plurality of validation parameters includes a maximum dollar amount of an aggregate sum of all coupons that can be issued.

5. The method of claim 1, wherein the step of setting a plurality of validation parameters includes setting a customized message to be displayed on the coupon.

6. The method of claim 1, further comprising generating a report for a plurality of parking event data stored by the central control computer, including the number of redeemed validation coupons for the merchant.

7. The method of claim 1, wherein the coupon is a QR code.

8. The method of claim 1, wherein the coupon is in electronic form.

9. The method of claim 1, further comprising displaying an advertisement on a display screen of the smart parking meter that indicates to the customer that the merchant will validate parking for purchases made from the merchant.

10. A method of validating a parking fee for a parking event occurring at a parking space monitored by a smart parking meter, the validation method comprising:
establishing a validation account by a merchant, including setting a plurality of validation parameters maintained in a memory of the central control computer system;
networking the smart parking meter with the central control computer;
networking a merchant point of sale (POS) system with the central control computer;
the merchant indicating to the central control computer via the POS system that the parking event for a customer is to be at least partially validated;
debiting the validation account of the merchant.

11. The method of claim 10, further comprising the central control computer matching a first credit card number used by the customer to make a purchase via the merchant POS system with a second credit card number used by the customer to purchase parking time via the smart parking meter.

12. The method of claim 10, further comprising the merchant POS system receiving a parking meter identification data corresponding to the smart parking meter monitoring the parking event to be validated.

13. The method of claim 12, wherein the parking meter identification data is a code shown on a customer's smartphone.

14. The method of claim 10, further comprising displaying an advertisement on a display screen of the smart parking meter that indicates to the customer that the merchant will validate parking for purchases made from the merchant.

15. The method of claim 10, wherein the step of setting a plurality of validation parameters includes a maximum dollar amount of an aggregate sum of all coupons that can be issued.

16. A parking monitoring and validation system, comprising:
a parking meter configured to automatically monitor a parking space; and
a central control computer located remotely from the parking meter, the central control computer being networked with the parking meter,
wherein the central control computer is configured to receive a merchant parking validation input and communicate to the parking meter that some or all of a parking event being monitored by the parking meter has been validated, and
wherein the central control computer is further configured to deduct a dollar amount corresponding to the merchant parking validation input.

17. The system of claim 16, further comprising a merchant POS system networked with the central control computer, wherein the central control computer is further configured to match a first credit card number used by the customer to make a purchase via the merchant POS system with a second credit card number used by the customer to purchase parking time via the parking meter.

18. The system of claim 16, wherein the merchant parking validation input is a QR code scanned via a smartphone application, wherein the smartphone is networked with the central control computer.

19. The system of claim 16, wherein the merchant parking validation input is a code scannable by a scanner included in the parking meter.

20. The system of claim 16, wherein the parking meter includes a display, and the central control computer is configured to command the parking meter to display a message advertising parking validation for customers making purchases from a merchant located within a pre-set proximity of the parking meter.
